(19) United States
(12) Patent Application Publication
(10) Pub. No.: US 2007/0292026 A1
(43) Pub. Date: Dec. 20, 2007

(54) Electronic magnification device

(76) Inventors: Leon Reznik, Sudbury, MA (US); Levy Ulanovsky, Sudbury, MA (US); Helen Reznik, Sudbury, MA (US); Sofya Gruman-Reznik, Sudbury, MA (US)

Correspondence Address: Leon Reznik, 52 Tanbark Rd, Sudbury, MA, 01776, US

(21) Appl. No.: 11/807,674

(22) Filed: May 30, 2007

Related U.S. Application Data
(60) Provisional application No. 60/809,642, filed on May 31, 2006.

(51) Int. Cl. G06K 9/36; G06K 7/10

(52) U.S. Cl. 382/176; 382/203; 382/321

(57) ABSTRACT

An electronic device is described that assists blind and/or low vision users in magnifying and reading printed text, fast book scanning and printing magnified images of said text. The device can also produce audio output that allows listening to the text being pronounced.

### CROSS REFERENCE TO RELATED APPLICATION

This application claims priority to provisional application No. 60/809,642 filed May 31, 2006

### FIELD OF THE INVENTION

The present invention relates generally to low vision and/or blindness enhancement systems and methods and, more particularly, to electronic devices that are capable of text image processing for assisting persons with low vision and/or blindness.

### BACKGROUND OF THE INVENTION

“Low vision” is often defined as chronic vision problems that generally cannot be corrected through the use of glasses (or other lens devices), medication or surgery. Symptoms of low vision are often caused by a degeneration or deterioration of the retina of a patient's eye, a condition commonly referred to as macular degeneration. Other underlying reasons of low vision include diabetic retinopathy, retinal pigmentosus and glaucoma.

To assist people with low vision, a number of vision enhancement systems have been developed. For the most part, these systems (usually closed circuit television or CCTV) include some type of video camera, an image processing system and a monitor. The viewed object is placed on the surface. The camera view is displayed on the screen. The camera has an optical zoom. As the camera zooms in, its field of view (FOV) becomes small, and only a small portion of the viewed object is seen on the screen. As a result, in order to read text lines from start to end, the user has to move either the camera or the viewed object. In order to ease process of reading with CCTV, a flat plate that can move left-right and forward-backward, called X-Y table is used.

As to text to speech capability, scanner based reading machines exist for the blind users that scan the page and read it aloud. Those machines have a number of deficiencies, such as slow scanning, large size, inconvenience in use, and inability to display magnified text in an easy to read form.

Some devices scan the page, perform OCR, and display OCR results on the screen. These can often wrap lines, so that they don't run off the screen. Those devices are problematic because of OCR errors.

Reading devices such as CCTV require physical movement of either the camera or the document to read the text of the document. Therefore it would be desirable to provide a device that allows a user to electronically scroll across an image of a document without the necessity of physically moving the document or the camera. Further, it would be advantageous to eliminate the need for horizontal scrolling of the text to be read and to make vertical scrolling alone sufficient. That can be accomplished by reformatting the text (line breaks) so that the end of a reformatted line on the screen is semantically contiguous to the beginning of the next line on the same screen. Further, it would be advantageous to accomplish such reformatting without OCR (optical character recognition), so that different languages and scripts can be processed.

Furthermore, it would be advantageous after processing the image and performing OCR to read the text, which is a result of the OCR to the user. Further it would be advantageous to make it possible simultaneous viewing of graphics and listening to the text. Further it would be advantageous to make it possible to print magnified text so that the end of a reformatted line on the printed page is semantically contiguous to the beginning of the next line on the same page.

The present invention removes the disadvantages of CCTV, scanner based reading devices, and other camera based devices, and provides a solution for people with blindness and low vision.

Objects of the present invention are:

1. Eliminate the need for horizontal scrolling of the magnified text to be read and make vertical scrolling alone sufficient.

2. Make the above processing script-independent, so that different languages and character-sets can be processed.

3. Make it possible to print magnified text so that the end of a reformatted line on the printed page is semantically contiguous to the beginning of the next line on the same page.

4. Electronically scan the image and instantly capture it, process, find text in the image and read it out to the user.

5. Provide a device that is capable of quickly and conveniently scanning a book without interruption while the user turns the pages over in the book, so that later on the text could be magnified, and/or reformatted, and/or read aloud.

6. Electronically convert images of pages to text and create one text file that contains the text of multiple pages.

7. Electronically scroll across a magnified image of a document without the necessity of physically moving the document or the camera.

### SUMMARY OF THE INVENTION

The invention includes a device system (an interconnected plurality of devices) for reformatting an image of printed text for easier viewing, which system comprises:

(a) A device for taking digital images; which device takes a first digital image of a string of unidentified (unrecognized) characters (a line of text)

(b) Space-software that identifies locations of spaces between said unidentified (unrecognized) characters;

(c) Splitting-software that splits said first image into essentially non-overlapping sub-images, each sub-image being cut out of said first image at one or more of said spaces between said unidentified (unrecognized) characters;

(d) Reformat-software that combines said sub-images into a reformatted [second] image where said sub-images are inserted one under the other;

(e) A device for displaying said reformatted image for viewing.

The invention also comprises a device described above, which comprises a motion detection device and enables scanning a set of pages, such as a book, by placing it in the FOV of a camera and leafing said pages, so that a page is held still after turning the previous page over, while using said motion detection device and an algorithm for determining that: (a) enough motion has been detected to determine that a page has been turned over, and that subsequently (b) motion has been below a preset threshold long enough to determine that a snapshot of the FOV should be taken.

The invention also comprises a method of differential display of characters recognized on a printed page by optical character recognition (OCR), in which method an estimate of OCR confidence of the correctness of the recognition is used for determining whether to display OCR processed characters, if the confidence is high enough, or original sub-images of such characters, if the confidence is not high enough.

The invention also comprises a device such as described above, which also performs optical character recognition (OCR) and text-to-speech processing of said printed text and thus pronouncing the text word by word.

The invention also comprises a device as above, which, in addition to pronouncing words, highlights the word that is being pronounced, so that the word that is being pronounced can be clearly identified on the display.

The invention also comprises a foldable support for a camera, which support, when unfolded, can be placed on a surface, on which surface it edges a right angle, which angle essentially marks part of the border of the field of view of said camera, for facilitating of placing of printed matter within said angle.

Such a support can have physical parts edging said right angle that are identifiable by touch for appropriate placement of printed material into said right angle, so that the material is fully fit into the angle.

One of the two sides of said right angle can be edged by a marker identifiable by touch to indicate the correct rotational placement of printed material.

The invention also comprises a device of one of the varieties described above, which device uses sound to convey to the user any information that may help the user in operating the device.

The invention also comprises a method of scanning a set of pages, such as a book, by placing it in the FOV of a camera and leafing said pages, so that a page is held still after turning the previous page over, while using a motion detection device and algorithm for determining that: (a) enough motion has been detected to determine that a page has been turned over, after which and that subsequently (b) motion has been below a preset threshold long enough to determine that a snapshot of the FOV should be taken.

The invention also comprises a method of scanning a book in which odd and even pages are photographed in separate snapshot series to minimize sideways movement of the book or the camera; the images resulting from the two snapshot series being then processed to order them in the correct order, as they were in said book.

If the odd side of the book is oriented differently from the even side of the book, a software algorithm can be used to rotate the images to restore the correct orientation.

The invention also comprises a method of scanning two pages of the book in the same scan or snapshot and identifying and separating those two pages into two separate pages using a software algorithm.

The invention also comprises a method of identifying lines that are not fully fit the camera field of view, and ignoring such lines.

### BRIEF DESCRIPTION OF THE DRAWINGS

FIG. 1—Camera support unfolded and deployed for exploitation.

FIG. 2—Camera support when folded.

FIG. 3—Individual parts of camera support shown unconnected.

FIG. 4—Collapsible foot joints and locks in unlocked state

FIG. 5—Collapsible foot joints and locks in locked state

FIG. 6—Foot shown separately from the base unit.

FIG. 7—Upper joint when unfolded and locked.

FIG. 8—Upper joint when folded.

FIG. 9—Example of a two-column page of text that contains a column that does not fit into the camera field of view.

FIG. 10—Flowchart of scanning a book in auto mode, with odd and even pages being scanned separately.

FIG. 11—Device operation flowchart.

### DETAILED DESCRIPTION OF THE PREFERRED EMBODIMENT

The system of the invention comprises the following devices: a high resolution CCD or CMOS camera with a large field of view (FOV), a mechanical structure to support the camera (to keep it lifted), a computer equipped with a microprocessor (CPU), and a monitor (Display). The invention also comprises methods for using all of the above.

The camera is mounted at a distance of 20-50 cm from the desktop (or table top) surface. The viewed object (a page of printed material) is placed on the desktop surface. The camera lens is facing down, where the viewed object is located. The field of view (FOV) of the camera is large enough so that a full 8½×11 page fits into it. The camera resolution is preferably about 3 Megapixels or more. This resolution allows the camera to capture small details of the page including small fonts, fine print and details of images.

In our example, a camera with the Micron sensor of 3 Megapixels was used. The camera is located about 40 cm above the desktop on which the object is placed. The lens field of view is 50°. That covers an 8½ by 11 page plus about 15% margins. The aperture of the lens is preferably small, e.g. 3.0. Small aperture enables the camera to resolve details over a range of distances, so that it can image a single sheet of paper as well as a sheet of paper on a stack of sheets (for example a thick book). In order to compensate for a low light pass of the small aperture, LEDs or another light source, whether visible or infrared, may need to be used to illuminate the observed object. LEDs that produced polarized light (or LEDs with polarized filter below can be used in order to reduce the glare. Furthermore, extra optical polarizer with polarization angle of 90° relative to the polarization angle of LEDs can be used further reduce the glare. Also circular polarized filter can be used on the lens.

The camera field of view (FOV) is large enough to cover a whole column of text or multiple columns of text or combination of text and pictures, such as a book page.

The camera is connected to a processor or a computer or CPU. The CPU is capable of doing image processing. The CPU also is capable of controlling the camera. Examples of camera control commands are resolution change, speed (frames per second, FPS) change or optical zoom change.

Mechanical Assembly

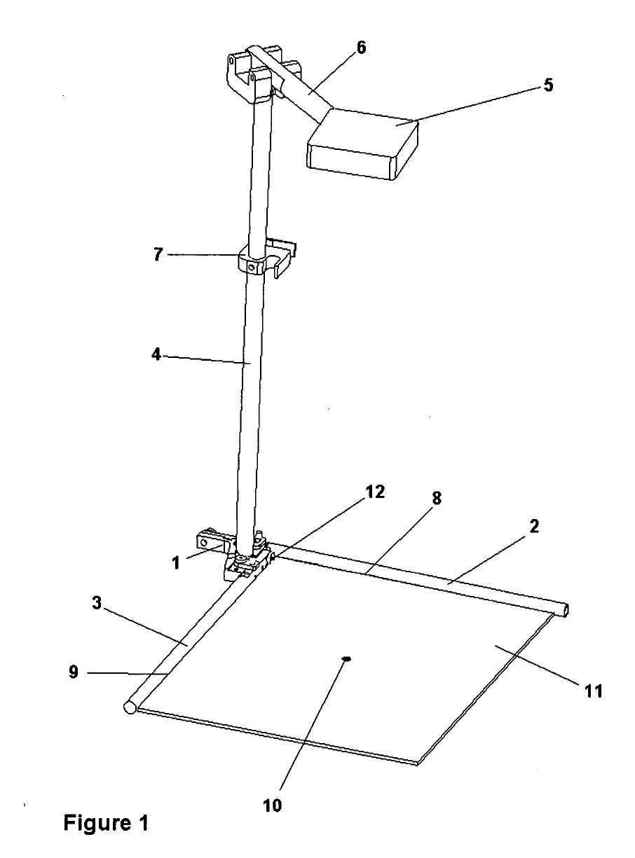

FIG. 1 illustrates the device in the unfolded operational position. Feet 2 and 3 are attached to base 1 at the right angle to each other and to pole 4. The feet are placed on a tabletop. Vertical pole 4 is attached to base 1. The camera and electronics are within enclosure box 5. Box 5 is attached to horizontal rod 6, which is attached to vertical pole 4. The camera in enclosure 5 has a lens facing down. The field of view (FOV) area of the camera covers an imaginable 8.5″ wide and 11″ long rectangle on the desktop surface. The long side of the FOV area rectangle (11″) runs along foot 3, and the short (8.5″) side of the FOV area rectangle runs along foot 2.

Viewed object 11, such as a paper sheet or a book, is placed in the rectangular area (FOV), framed on two sides by feet 2 and 3. Correct placing of object 11 into the FOV becomes easy, since feet 2 and 3 are identifiable by touch.

Long foot 3 and short foot 2 are connected to base 1 by shoulder screws 54 and 55 respectively (see details below). The head of shoulder screw 54, which is located by the long side of the FOV rectangle, can be used by a blind person as a marker to identify the longer side of the FOV for proper placement (rotation) of the viewing viewed object.

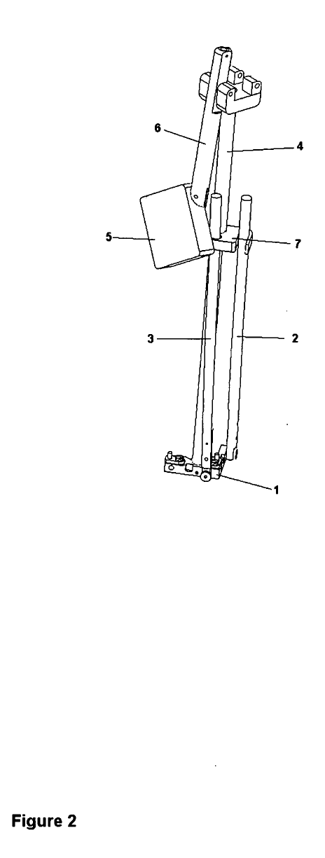

FIG. 2 illustrates the device when folded. Feet 2 and 3 are lifted (turned) up, and are latched by the slots of foot catch 7. Horizontal rod 6 attached to camera enclosure 5 is folded down.

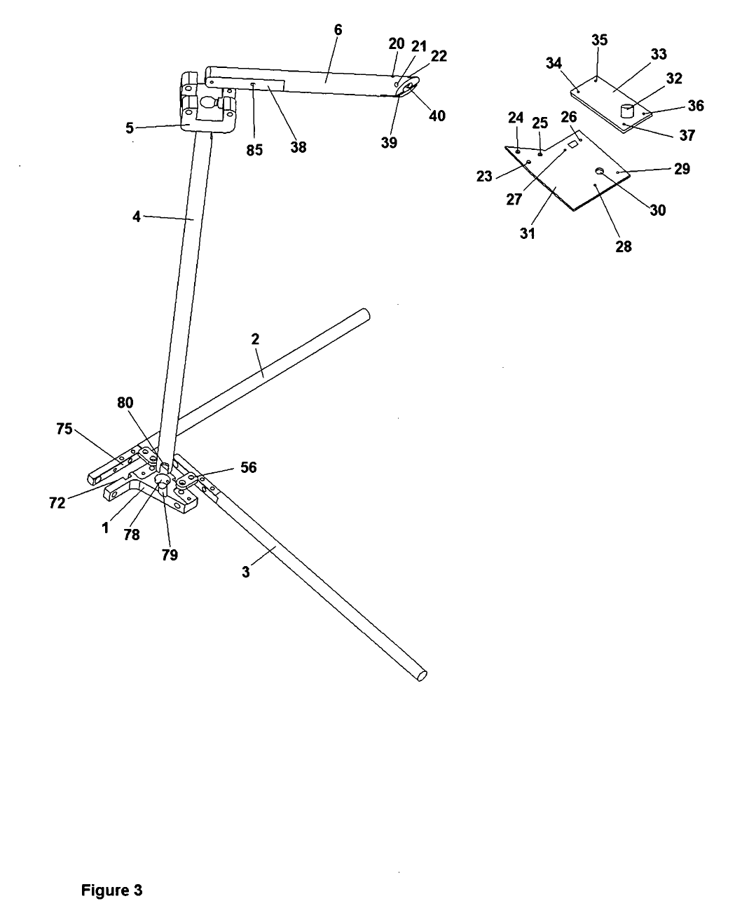

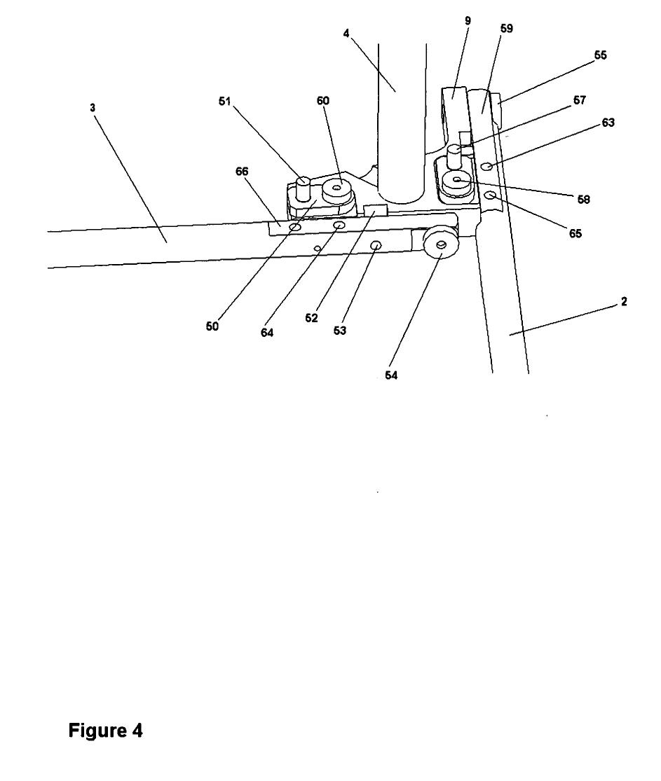

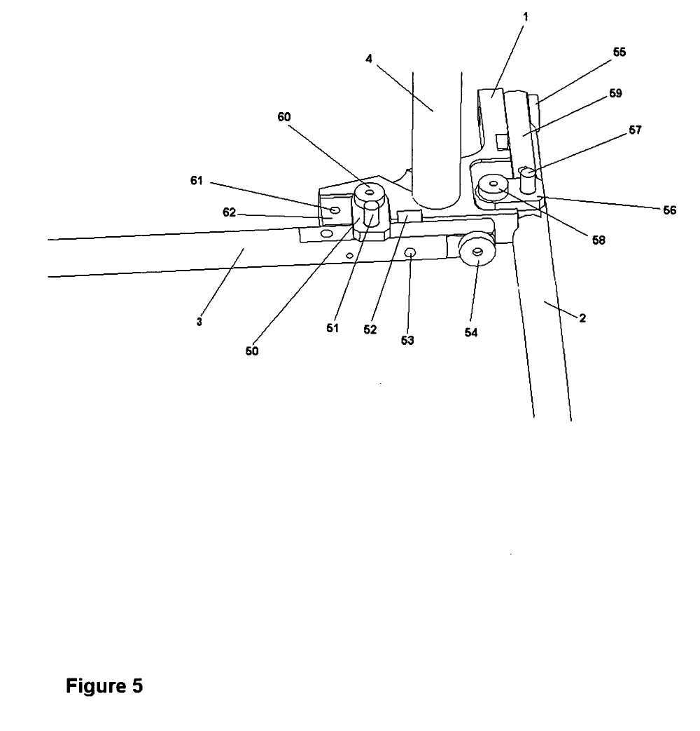

FIG. 3 schematically shows the entire support for the camera. Vertical pole 4 is press-fitted to hole 78 of base 1. Two feet (2 and 3) are attached to base 1 such that they make the support structure stable when unfolded and at the same time can be folded (see detailed description for FIGS. 4 and 5). Top bracket 5 is affixed to vertical pole 4 as described with respect to other figures. Horizontal rod 6 is attached to top bracket 5 by axis that goes through hole 86 on horizontal rod 6 and hole 83 on top bracket 5. Top bracket 5 can be folded down (to be roughly parallel to pole 4) or unfolded and fixed at about 90° to pole 4. The 90° fixation is achieved by two ball plungers that are placed in threaded holes 84 and 86. See below for details. Lower PCB (printed circuit board) 31 is attached to horizontal rod 6 by three screws that go through holes 20, 21, and 22 on horizontal rod 6, and holes 23, 24, and 25 on PCB 31.

FIG. 3 shows camera board 33 upside down in order to show lens 32. Camera board 33 is mounted on top of Lower board 31 at a distance of approximately ½″ using four screws and four stand offs that go through holes 26, 27, 28, 29 in Lower PCB 31, and holes 34, 35, 36, 37 in Camera board 33. When Camera board is mounted to Lower board 31, the center of lens 32 is over lens hole 30 on Lower PCB 31. Depending on the type and length of lens 32, the bottom of the lens can be above or below the level of Lower PCB 31.

The whole assembly is positioned such that the center of the lens projects onto the horizontal surface (table top surface) 4.25″ and 5.5″ from legs 3 and 2 respectfully.

A wire is passed inside hollow wire-way 40 in horizontal rod 6. It exits before the end of rod 6 and enters vertical pole 4 wire-way through its end 87 continuing down and exiting at the bottom via cut-out 80 near base 1. One side of the wire connects to PCB 31, and the other side comes out at the bottom of vertical pole 4 through cutout 80 in vertical pole 4 and groove 79 in base 1 continuing to the USB connection in a computer.

Foot Assembly And Locking

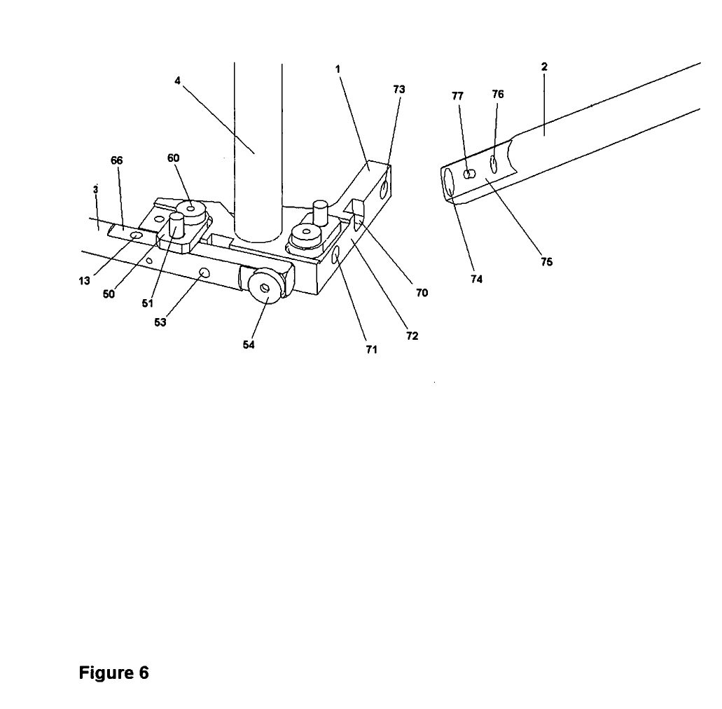

Foot assembly and attachment to base 1 is schematically illustrated on FIG. 6. Both feet are attached and locked in the same way, in this example. Foot 2 is attached to base 1 by shoulder screw 55 that goes through hole 74 in foot 2 and screws into threaded hole 73 on base 1.

Pin 77 together with cutout 70 serves as a stopper that allows foot 3 to be folded (turned) up, but does not allow it to be turned down more than 90° to pole 4.

Furthermore, ball plunger [not shown] is screwed in to threaded hole 77 on base 1. Foot 2 has indentation (a small circular hole or detent) 76 on surface 75. The indentation is located such that when foot 2 is unfolded 90° relative to vertical pole 4, the ball plunger ball falls into indentation 76, and fixes foot 2 in place.

In addition to ball plunger locking mechanism described above, there is a firm locking mechanism that prevents the feet from collapsing (turning to the pole) while locked. This mechanism is illustrated on FIGS. 4 and 5. Feet 2 and 3 can rotate around shoulder screws 55, 54 for folding (see FIG. 2).

Lock plates 50 and 56 are used to lock the feet in place when the unit is unfolded. Lock plate 50 rotates 90 degrees around small shoulder screw 60. When turned by 90 degrees (see FIG. 4) it is blocking foot 3 from folding up. Foot 3 has indentation 64, and locking plate 50 has ball plunger 51. In the fully locked position ball plunger 51 clicks into indentation 64, and stays in place. The same ball plunger 5 clicks, when in fully unlocked position, into indentation 61 on surface 62 on base 1.

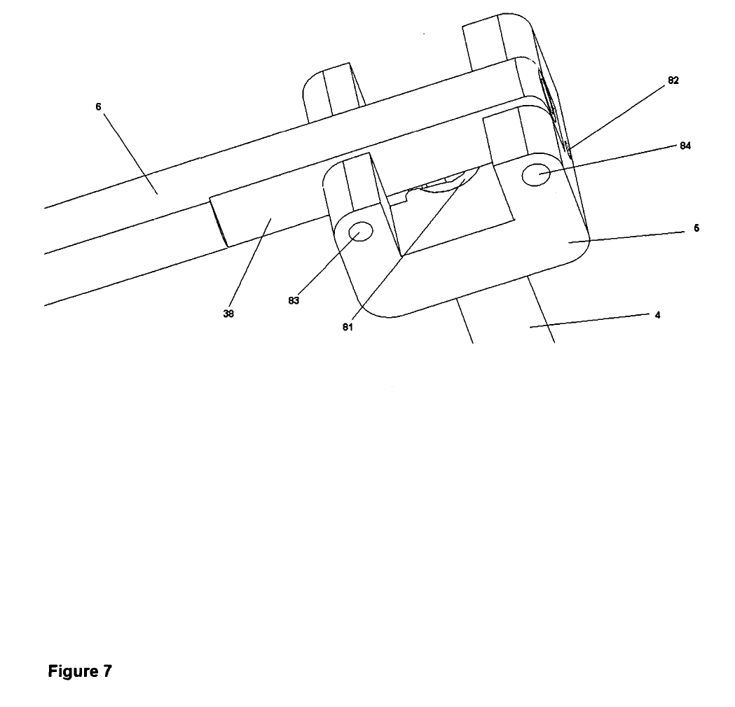

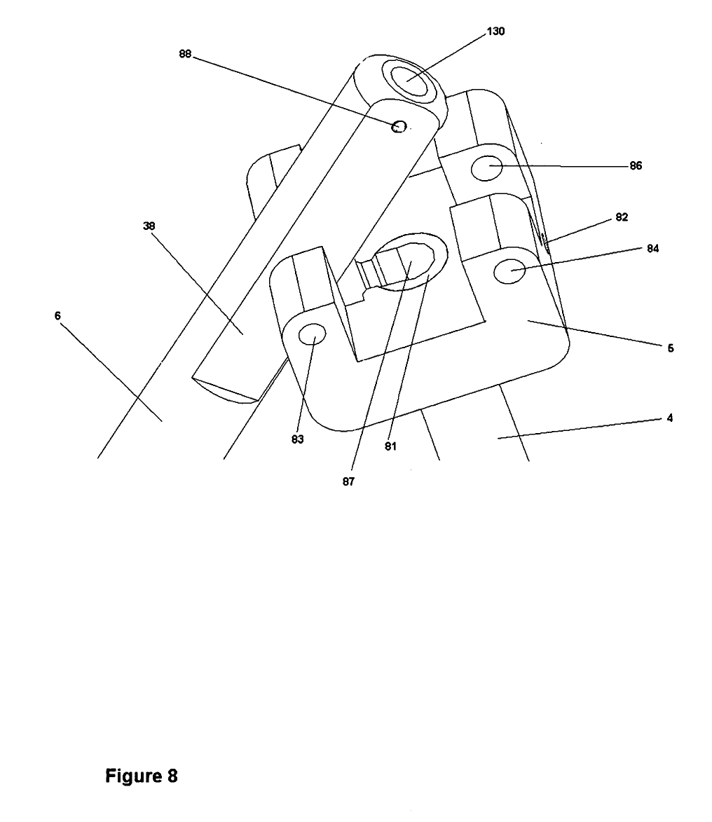

FIGS. 7 and 8 schematically illustrate attachment of upper bracket 5 to vertical pole 4, and attachment of Horizontal rod 6 to top bracket 5. Horizontal rod 6 rotates around axis that is inserted into hole 83 on upper bracket 5 and hole 85 on horizontal rod 6. Two ball plungers are screwed into threaded holes 84 and 86, such that the balls face each other. Horizontal rod 6 has indentation 88 on both sides. When in unfolded horizontal position, the ball plunger locks into indentation 88 and holds rod 6 horizontal, at the right angle to pole 4, until sufficient force is applied to unlock the ball plungers and thus turn rod 6 down. This force eventually turns rod 6 to become near-parallel to pole 1, as seen in FIG. 2.

The camera produces either Monochrome or raw Bayer image. If a Bayer image is produced, then computer (CPU) converts the Bayer image to RGB. The standard color conversion is used in video mode (described below). Conversion to grayscale is used if text in the image is going to be reformatted and/or processed otherwise as described below. The grayscale conversion is optimized such that the sharpest detail is extracted from the Bayer data.

The system can work in various modes:

1. Video Mode.

In Video Mode, the CPU is receiving image frames from the camera in real time and displaying those images on the monitor screen. Video Mode allows the user to change the zoom or/and magnification ratio, and pan the FOV, so that the object of interest fits into the FOV. While in Video Mode, the camera may operate at a lower resolution in order to accommodate for faster frame rate. Video Mode allows zooming in and out (optically or/and digitally).

1a. Orientation.

In Video Mode the displayed image can be rotated by 90 degrees at a time as the user pushes a button. As a result, the printed material can be placed portrait, landscape, or portrait upside down or landscape upside down, but after the rotation the image will be shown correctly on the screen. At a subsequent mode the image processing will automatically rotate the image by an angle needed to make the lines as close to horizontal as possible.

2. Capture Mode.

Capture Mode allows the user to freeze the preview at the current frame and capture a digitized image of the object into the computer memory, i.e. to take a picture. For the purpose of this embodiment we assume that the object is a single-column page of text. We will refer to the captured image as ‘unreformatted image’. Unlike in the subsequent modes, here the user usually views the captured image as a whole. One purpose is to verify that the whole text of interest (page, column) is within the captured image. Another is to verify that no, or not too much of, other text (parts of adjacent pages or columns) or picture is captured. If the captured image is found inadequate in this sense, the user goes back to Video Mode, moves and/or zooms the FOV and captures again. The user can also cut irrelevant parts out or brush them white.

3. Unreformatted View Mode.

Unlike in Capture Mode, here the captured image is magnified and can be processed in other ways mentioned above. But the text lines are not yet reformatted. The magnification level can be tuned now and selected to be optimal for reading. The selected level of magnification is then set at this stage for subsequent reformatting. Software image enhancements methods can be used to make words and letters more readable.

4. Reformatted Text Mode.

In Reformatted Text Mode, the CPU has processed the captured image and converted (reformatted) it into a reformatted image. This reformatted image is a single column text that fits the width of the screen. Thus the locations of the ends and beginnings of lines relative to said text message are different in the reformatted image compared such locations in the captured image. The reformatting changes the number of characters per line, so that the new line length fits the size of the screen at the chosen magnification. In other words, if no reformatting is done, the magnified lines run off the screen. By contrast, in the reformatted image they do not. In the reformatted image the lines wrap, so that the end of a reformatted line on the screen is semantically contiguous to the beginning of the next line on the same screen.

During the image processing, the software does the following:

Identifies if the object is a column of printed text.

Identifies the lines of the text.

Identifies location of spaces between characters and/or words in the lines.

Reformats the text lines as described in mode 4 above by moving line breaks into space locations that may be different from where the breaks were in the text of the captured image.

If the object is printed material with text, then the CPU will identify the text lines, then it will identify the locations of words (or characters) in lines, and then it will reformat the text into a new image such, that the text lines wrap around at the screen boundaries (fit the display width). Alternatively, for the purpose of printing, the new column of magnified text, when reformatted should fit the page (width) in the printer.

Rejection of a Column that is Captured in Part

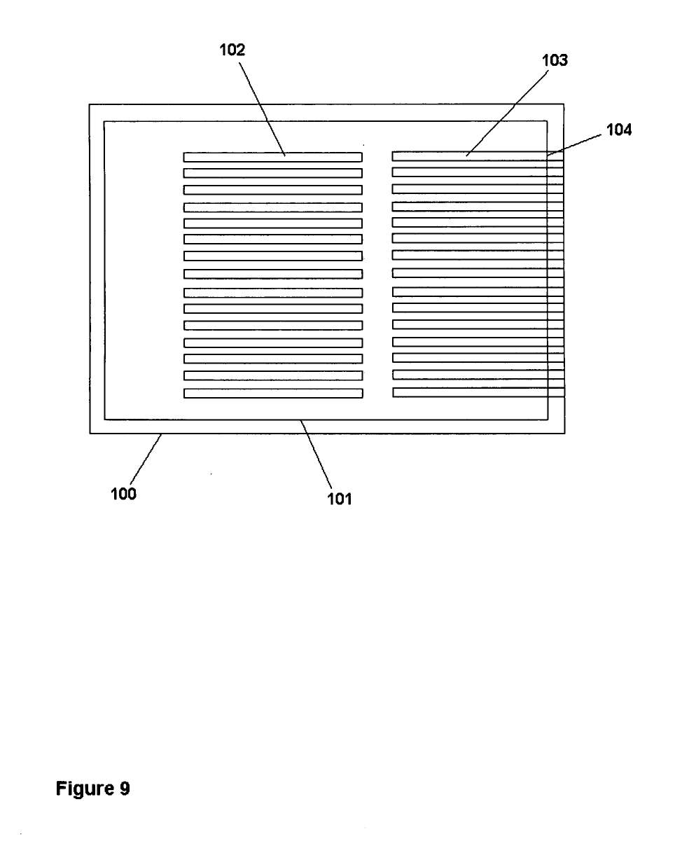

FIG. 9 illustrates an example of a two-column text page to be scanned by the device of the invention. Left column 102 fully fits in the camera field of view. Right column 103 does not fully fit in the camera field of view, and as a result should not be displayed in the reformatted text mode, nor be read out loud, nor should be printed, nor saved as text.

If a column on the page (viewed object) is not fully in the FOV of the camera horizontally, i.e. if there is at least one line in the column, part of which is not in the FOV, and part is in the FOV, such a line should be detected. Note that there is a possibility that some of the lines in the column or section are fully in the FOV, and some have parts that are not in the FOV. This situation can happen, for example, when the viewed object is not places straight, i.e. the text lines are not parallel to the edge of FOV. In the situation when only some of the lines of the column/section are not fully in FOV, it is not always necessary to ignore for the purpose of processing the whole column/section. Some lines that are fully in the FOV may need to be processed. In order to detect a line that does not fit fully into FOV, the following method is used. The total FOV 100 of the camera is slightly larger then FOV 101, which is displayed to the user. Only what fits in a smaller FOV 101 will be processed, OCR-ed or reformatted. The software sees that the lines in column 103 go beyond the boundary of right edge of a smaller FOV rectangle 101, intersecting it at point 104, and continues to the right. That indicates that at least the line does not fit into smaller FOV 101, and perhaps not even in total FOV 100. As a result, column 103 is going to be ignored (not shown and/or red to the user).

Line Straightening:

In addition, optionally, two methods of straightening the lines of printed text can be used in the present invention, either separately or combined:

A. Physical straightening of the page. One problem of photographing (capturing a snapshot of the image) of an open book is that the pages are rarely flat. A person can make a book page flatter by pushing near the four corners of the page using two hands. Then the person needs an additional hand to trigger the camera while still pushing the page. The problem to solve here is that people have two hands at most. The present invention uses a motion detector that senses motion in its field of view. When it detects motion, it waits till that motion ends. When it detects that the motion has ended, it automatically triggers the capture of the page image—a snapshot. In this way both hands can be used to keep the page flat. An algorithm is used in the present invention that is based on movement detection and image analysis in video mode of the camera. Only after motion starts, then stops, and the image stays still for N frames, or time T, then a snapshot is taken. N (T) is a preset parameter that is subject to resetting when necessary. An audio and/or visual indicator can optionally signal to the user when a snapshot is taken.

The above method is useful in particular while scanning a book in Book Mode described below. While a book page is being flipped, motion is seen in the camera FOV. After the user finished flipping the page and holds the book page, the image in the camera FOV becomes still. Then the software triggers a snapshot.

B. Software for straightening the lines. First, the software approximates the shape of a line of text with a polynomial curve. Once the best fit is found, the line can be remapped to a straight shape using the usual techniques. For example the line can be divided into a collection of trapezoids and each trapezoid can be mapped to a rectangle using bilinear transformation:
x′=a+b*x+c*y+d*xy
y′=e+f*x+g*y+h*xy

This is similar to the last stage of the process in Adrian Ulges, Christoph H. Lampert, Thomas M. Breuel: Document Image Dewarping using Robust Estimation of Curled Text Lines. ICDAR 2005: 1001-1005.

Saving a Snapshot

A snapshot of current preview frame can be saved in storage media attached to the CPU, such as a hard drive or any external drive. Taking a snapshot is a very quick operation. Prior to taking a snapshot the software must check that the camera is in a stable state, e.g. it is not in a process of auto brightness adjustment.

Device Operation

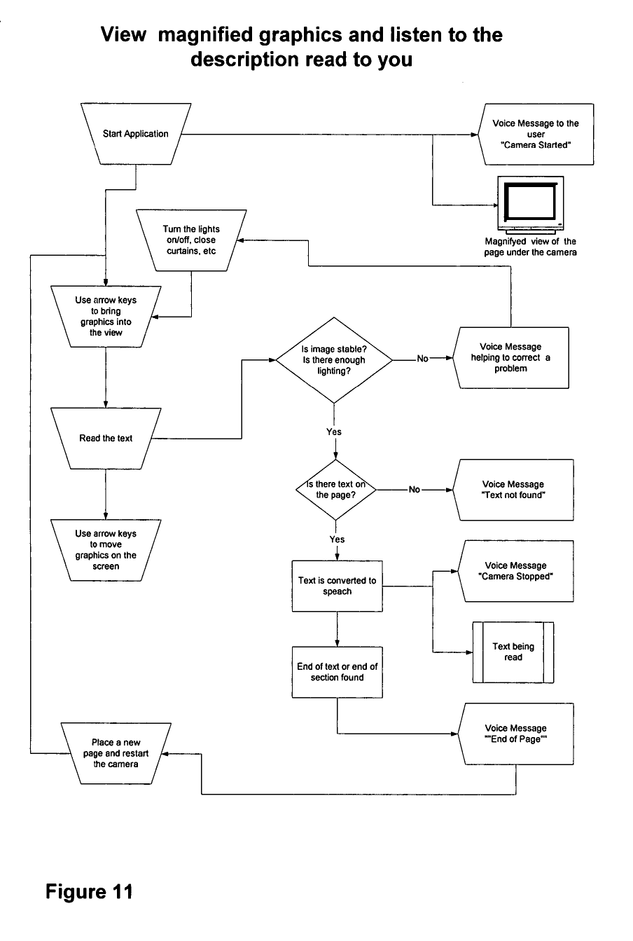

FIG. 11 is a flow chart that illustrates an example of the invented device basic operation. In the basic operation the user inserts the printed matter under the camera, views it in an easy to read magnified mode, and listens to the text spoken out by text-to-speech. On the left of the diagram are user actions. On the right are machine actions. In the middle is program logic.

Book Mode

Book Mode is used to scan the whole book or a multi-page document. It enables the user to select the start page, and as the device saves subsequent page images, it updates the internal structure that keeps track of the pages saved. Each saved page has an associated number in the order of the page numbers in the book or document.

Moreover, Book Mode allows the user to scan pages on one side of the book (e.g. even pages) first, and then all the pages on the other side of the book (e.g. odd pages) (or vice versa). The software will automatically re-arrange the pages and put them in the correct order.

Moreover, while scanning one side of the book, the user may put the book in one orientation relative to the device, and then when scanning the other side the user may put the book in a different orientation. For example the user can hold the book up side up while scanning even pages, and then turn the book up side down to scan odd pages. The software will save and remember the orientation of both sides of the book. It will then display the text correctly.

Moreover, while scanning the book, the determination if the time when a snapshot for a current page can be taken can be used with motion detection method described in subsection a. of Line Straightening section. When the software detects motion of a hand and of a page, it registers the motion, and when the image became and remains still, the software triggers a snapshot and advances the page number, giving a user audio and/or visual indication that the current page is taken. This audio and/or visual indication is a sign to the user that he/she can flip the next page. This method of scanning a book enables the user to scan the whole book without pushing a button for every page scanned.

Moreover, while scanning a book, which is small enough, and two pages (left and right) can both fit within the FOV of the camera, both pages can be scanned at once. In this case, the software will order the pages accordingly. Moreover, the software can determine the boundary of two pages, and separate one image with two pages into two separate images of two pages. The algorithm for finding the boundary is the following. The software performs projections of the image onto several lines at different angles to the horizontal axis. Two peaks and a valley are searched in each projection. If in one of the projections peak and valleys are detected reliably enough, then, the software divides the two pages in the middle of the valley.

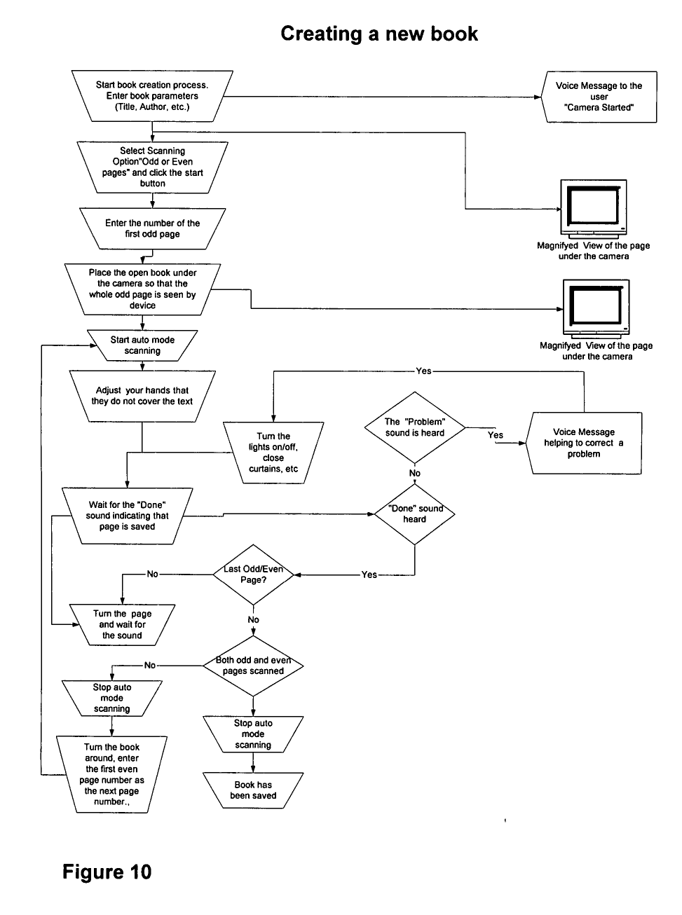

FIG. 10 provides an example of scanning a book using odd and even pages in automatic mode. The diagram shows a sequence of actions needed to scan the book. On the left of the diagram are user actions. On the right are machine actions. In the middle is program logic. Initially the user has to select the method, which is scanning odd or even pages. Then the user sets the first page number to be scanned, say 1. Then the user places page 1 in the FOV of the camera, and waits for the audio or visual indication that page is scanned. Then the user simply turns the page, and scans page 3, and so on. After the odd pages are scanned, the user sets the page number to 2, rotates the book, and places page 2 in the FOV of the camera. After audio or visual indication, the user goes to page 4, and waits for audio or visual indication again, and so on until the whole book is scanned. After the whole book is scanned, the software orders the pages in the right order. The user has to indicate the right rotation (orientation) for the first (or any other odd) and second (or any other even) pages. The software then rotates the rest of the page images appropriately.

Sound Output

As blind people cannot see, they cannot watch the state of hardware, software and other useful information. The latter includes, but is not limited to:
Whether the camera is running or stopped;
Orientation of the lines within the page (e.g. portrait/landscape);
If the page is upside down or not;

In order to help blind person use the invented device, sound output feature is introduced to indicate such information. The software produces appropriate sounds such as human voice informing the user.

Use of OCR Confidence Values for Individual Characters.

The reformatting as described above is performed without recognizing any characters as known alphanumeric characters. In other words, the reformatting is done without what is known as OCR (optical character recognition). OCR is done separately from the reformatting, and only if necessary. For example, OCR may be needed for subsequent text-to-speech conversion, i.e. reading aloud of the recognized text. In this specific application it may also be helpful to highlight the word that is being read vocally.

One optional feature of the present invention is what can be called “differential display” of characters after OCR is performed. The “differential display” of characters works by displaying well recognized characters using an appropriate font, while displaying images of less well recognized characters “as they are”, this is to say the way those images are captured by the camera, in its snapshot. This is done to minimize the errors of character recognition. To do this, characters are ascribed confidence values in the process of OCR. Those values correspond to the level of reliability of recognition by the OCR software. This level may depend on such factors as illumination, print quality, angle of view, contrast, similarity between alternative characters, etc. Then a threshold is set within the range of confidence values (and can be reset). This threshold will separate 1) higher confidence characters to be displayed using an appropriate font from 2) lower confidence characters to be displayed “as they are”.

OCR can also be used to differentiate between “real” text and noise or other object in the camera view that may look like text. An example of such an object is a picture that has a number of thick horizontal lines. As the threshold is set for OCR confidence, words that have confidence below the threshold are not shown, or alternatively shown as pictures.

Process Steps 1 to 4:

Here is an example of the sequence process steps 1 to 4 outlined above:

Prompted by the user in Capture Mode, the CPU captures the current frame (an image of a page of text) into the computer memory.

The CPU performs image thresholding and converting the image to one-bit color (two-color image, e.g. black and white).

The image is rotated to optimize the subsequent line projection result. The rotated image, or part of it, is then horizontally projected (i.e. sideways), and lines are identified on the projection as peaks separated by valleys (the latter indicating spacings between lines). This step, starting from rotation, can be repeated to achieve horizontality of the lines.

Spaces between words (or between characters, in a different option) are identified by finding valleys in vertical projection of line image, one text line at a time. Finding all of the spaces may not be necessary, just a sufficient number of spaces need to be identified to choose new locations for lines breaks.

Paragraph breaks are identified by the presence of at least one of the following: i) unusually wide valley in the horizontal (sideways) projection, ii) unusually wide valley in the vertical projection at the end of a text line, or/and iii) unusually wide valley in the vertical projection at the beginning of a text line.

A rectangle surrounding each word/character image is superimposed on the image. The borders of such rectangles are drawn in the minima of the horizontal and vertical projections mentioned above.

Within each paragraph, the rectangles are numbered (ordered) from left to right within text lines. Upon reaching the right end of a line, the numbering is continued from the beginning (left end) of the next line. Until this point the processing dealt with the unreformatted (original) image. This unreformatted (original) image is then converted into a reformatted image as follows. The left border for the reformatted image is drawn perpendicular to the text lines and shifted to the left (by a preset distance) of the left ends of text lines. The right border is drawn parallel to and shifted to the right of the left border. The shift distance is the number of pixels that fit on user's screen in the Unreformatted View Mode at the time of the command by the user to switch to Reformatted Text Mode.

The reformatting begins from counting how many rectangles of the first line in the original unreformatted image fit between said left and right borders of the reformatted image. The counting starts from the first rectangle of the paragraph, proceeding rectangle-by-rectangle along the line. These are transferred, including the image within them, in unchanged order and relative position (next to each other) to the reformatted image.

Once a rectangle (the next to be transferred) is reached closer than a preset distance (measured in pixels) from the right border, such rectangle is transferred, including the image within it, to the start of the next line of the reformatted image. The subsequent rectangles are placed in the same order and position, adjacent to each other. The procedure of this step is continued till the end of the paragraph.

A paragraph break is then made in the reformatted image. And then the next paragraph is similarly reformatted. The reformatting proceeds till the end of the captured image is reached. The rectangle lines (borders) are not shown in the reformatted image.

The reformatted image can then be optionally printed so that the end of a reformatted line on the printed page is semantically contiguous to the beginning of the next line on the same page.

We claim:

1. A device system for reformatting an image of printed text for easier viewing, which system comprises:
(a) a device for taking digital images; which device takes a first digital image of a string of unidentified (unrecognized) characters;
(b) space-software that identifies locations of spaces between said unidentified (unrecognized) characters;
(c) splitting-software that splits said first image into essentially non-overlapping sub-images, each sub-image being cut out of said first image at one or more of said spaces between said unidentified (unrecognized) characters;
(d) reformat-software that combines said sub-images into a reformatted [second] image where said sub-images are inserted one under the other; and
(e) a device for displaying said reformatted image for viewing.

2. Device of claim 1, which comprises a motion detection device and enables scanning a set of pages, such as a book, by placing it in the FOV of said high resolution camera and leafing said pages, so that a page is held still after turning the previous page over, while using said motion detection device and an algorithm for determining that:
(a) enough motion has been detected to determine that a page has been turned over, and that subsequently
(b) motion has been below a preset threshold long enough to determine that a snapshot of the FOV should be taken.

3. A device that comprises a motion detection device and enables scanning a set of pages, such as a book, by placing it in the FOV of said high resolution camera and leafing said pages, so that a page is held still after turning the previous page over, while using said motion detection device and an algorithm for determining that:
a. enough motion has been detected to determine that a page has been turned over, and that subsequently
b. motion has been below a preset threshold long enough to determine that a snapshot of the FOV should be taken.

4. A method of differential display of characters recognized on a printed page by optical character recognition (OCR), in which method an estimate of OCR confidence of the correctness of the recognition is used for determining whether to display OCR processed characters, if the confidence is high enough, or original sub-images of such characters, if the confidence is not high enough.

5. Device of claim 1, which performs optical character recognition (OCR) and text-to-speech processing of said printed text and thus pronouncing the text word by word.

6. Device of claim 5, which, in addition to pronouncing words, highlights the word that is being pronounced, so that the word that is being pronounced can be clearly identified on the display.

7. A foldable support for a camera, which support, when unfolded, can be placed on a surface, on which surface it edges a right angle which angle essentially marks part of the border of the field of view of said camera, for facilitating of placing of printed matter within said angle.

8. Support of claim 7 in which support physical parts edging said right angle are identifiable by touch for appropriate placement of printed material into said right angle, so that the material is fully fit into the angle.

9. Support of claim 7, in which one of the two sides of said right angle is edged by a marker identifiable by touch to indicate the correct rotational placement of printed material.

10. Device of claim 1, which device uses sound to convey to the user any information that may help the user in operating the device.

11. Device of claim 1, which identifies multiple columns and sections of text, and arranges those columns and sections in the right order.

12. Device of claim 1, which identifies multiple columns or sections of the text and also identifies each column or section which has one or more line that are not entirely in FOV of the camera, and ignores such columns or sections or ignores parts of such columns or sections.

13. Device of claim 1, which also comprises software that is capable of printing scanned magnified text in reformatted form.

14. A method of scanning a set of pages, such as a book, by placing it in the FOV of a camera and leafing said pages, so that a page is held still after turning the previous page over, while using a motion detection device and algorithm for determining that:
a. enough motion has been detected to determine that a page has been turned over, and that subsequently
b. motion has been below a preset threshold long enough to determine that a snapshot of the FOV should be taken.

15. A method of scanning a book in which odd and even pages are photographed in separate snapshot series to minimize sideways movement of the book or the camera; the images resulting from the two snapshot series being then processed to order them in the correct order, as they were in said book.

16. Method of claim 14 with the possibility of the odd side of the book being oriented differently from the even side of the book; in which method a software algorithm is used to rotate the images to restore the correct orientation.

17. Method of scanning two pages of the book in the same scan or snapshot and identifying and separating those two pages into two separate pages using a software algorithm.
